(19) United States
(12) Patent Application Publication
(10) Pub. No.: US 2005/0048401 A1
(43) Pub. Date: Mar. 3, 2005

(54) Methods of photoaddressing a polymer composition and the articles derived therefrom

(76) Inventors: Bret Ja Chisholm, Clifton Park, NY (US); Michael Jeffrey McLaughlin, Albany, NY (US)

Correspondence Address: CANTOR COLBURN, LLP, 55 GRIFFIN ROAD SOUTH, BLOOMFIELD, CT, 06002, US

(21) Appl. No.: 10/652,016

(22) Filed: Aug. 29, 2003

(51) Int. Cl. G11B 7/24

(52) U.S. Cl. 430/270.14; 430/945; 219/121.65

(57) ABSTRACT

A method for manufacturing data storage media comprising irradiating at least a portion of an organic polymer comprising a resorcinol arylate polyester with a UV beam having a wavelength of about 290 to about 700 nanometers so as to impart an energy of about 1 to about 20 milliwatt/square centimeter to the irradiated portion of the organic polymer.

### BACKGROUND

This disclosure is related to methods of photo addressing a polymer composition and the articles derived therefrom.

Photosensitive materials have often been used for recording data in the form of holograms. Photosensitive materials that are used for such data recording generally contain cyclohexyl methacrylate and N-vinylcarbazole as photo-polymerizable monomers. However, such materials generally use photo initiators as well as stabilizers to effect curing and to stabilize the material so as to retain the data without damage after it has been recorded. Unfortunately, the continued presence of monomer after the data has been recorded causes the reproduction of the data to diminish with the passage of time. This necessitates additional treatments such as additional exposure to UV radiation in order to stabilize the data storage media.

There is therefore a need for materials that can be used as data storage devices that can retain the data without the addition of initiators and stabilizers and which do not degrade with time.

### BRIEF DESCRIPTION OF THE INVENTION

A method for manufacturing data storage media comprises irradiating at least a portion of an organic polymer comprising a resorcinol arylate polyester with a UV beam having a wavelength of about 290 to about 700 nanometers so as to impart an energy of about 1 to about 20 milliwatt/square centimeter to the irradiated portion of the organic polymer.

### BRIEF DESCRIPTION OF THE FIGURES

FIG. 1 depicts a Fries molecular rearrangement brought about by the irradiation of the organic polymer; and

FIG. 2 is a graphical representation of the change in refractive index for an organic polymer upon being irradiated by UV light.

### DETAILED DESCRIPTION OF PREFERRED EMBODIMENTS

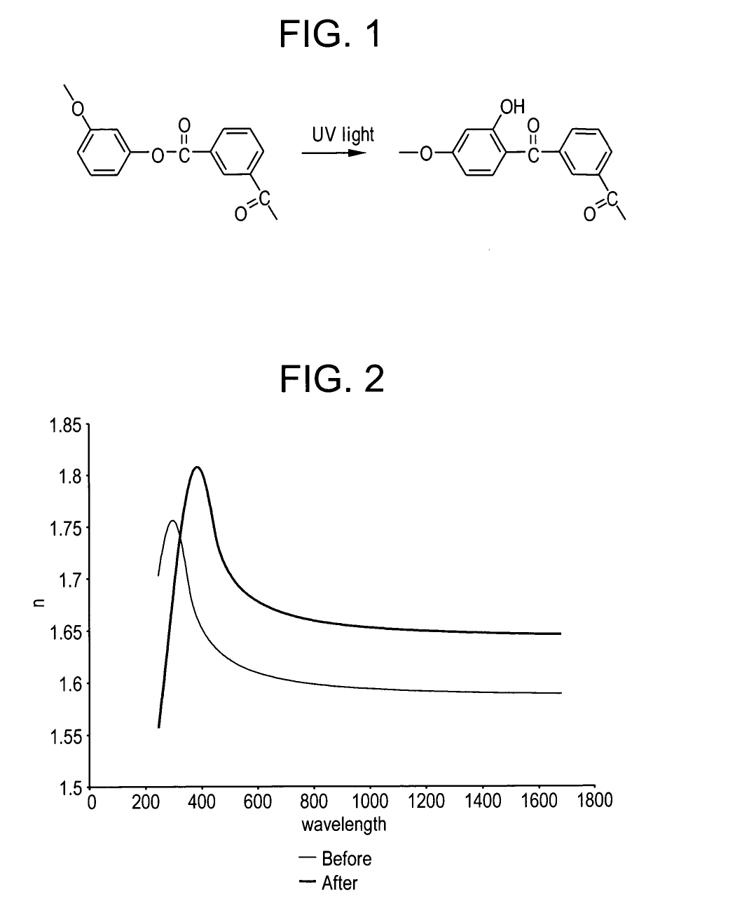

Disclosed herein are data storage media comprising organic polymers, wherein the data storage capabilities are produced as the result of a pattern manufactured in the organic polymer. The pattern is manufactured by irradiating the organic polymer with ultraviolet (UV) light that results in a Fries molecular rearrangement in the irradiated regions of the organic polymer. This rearrangement is depicted in the FIG. 1. The Fries molecular rearrangement brings about a difference in refractive index between the irradiated regions and those regions that are not irradiated and this difference results in a pattern that can be used as a data storage media. The pattern can be advantageously produced in materials having various geometrical shapes such as films, slabs, plates, blocks, and the like, and can be used in the formation of exterior body panels, waveguides and photonic communication devices.

In one embodiment, the pattern may be manufactured in a film having at least one layer. In another embodiment, the pattern may be manufactured in a film having two or more layers. When a film comprises two or more layers, the pattern may be manufactured in either a single layer or in more than one layer.

The organic polymers are those that are capable of undergoing a Fries molecular rearrangement upon irradiation by UV light. Examples of such organic polymers are polycarbonates, polyesters such as resorcinol arylate polyesters, copolyestercarbonates, or the like, or combinations comprising at least one of the foregoing organic polymers.

Suitable organic polymers for use in the data storage devices are polycarbonates, resorcinol arylate polyesters, blends and copolymers of polycarbonates with polyesters. As used herein, the terms “polycarbonate”, “polycarbonate composition”, and “composition comprising aromatic carbonate chain units” includes compositions having structural units of the formula (I): 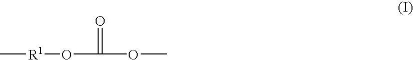
in which greater than or equal to about 60 percent of the total number of R¹ groups are aromatic organic radicals and the balance thereof are aliphatic, alicyclic, or aromatic radicals. Preferably, R¹ is an aromatic organic radical and, more preferably, a radical of the formula (II):
-A¹-Y¹-A²- (II)
wherein each of A¹ and A² is a monocyclic divalent aryl radical and Y¹ is a bridging radical having zero, one, or two atoms which separate A¹ from A². In an exemplary embodiment, one atom separates A¹ from A². Illustrative examples of radicals of this type are —O—, —S—, —S(O)—, —S(O)₂—, —C(O)—, methylene, cyclohexyl-methylene, 2-[2,2,1]-bicycloheptylidene, ethylidene, isopropylidene, neopentylidene, cyclohexylidene, cyclopentadecylidene, cyclododecylidene, adamantylidene, or the like. In another embodiment, zero atoms separate A¹ from A², with an illustrative example being biphenyl. The bridging radical Y¹ can be a saturated hydrocarbon group such as methylene, cyclohexylidene or isopropylidene.

Polycarbonates may be produced by the Schotten-Bauman interfacial reaction of the carbonate precursor with dihydroxy compounds. Typically, an aqueous base such as sodium hydroxide, potassium hydroxide, calcium hydroxide, or the like, is mixed with an organic, water immiscible solvent such as benzene, toluene, carbon disulfide, or dichloromethane, which contains the dihydroxy compound. A phase transfer agent is generally used to facilitate the reaction. Molecular weight regulators may be added either singly or in admixture to the reactant mixture. Branching agents, described forthwith may also be added singly or in admixture.

Polycarbonates can be produced by the interfacial reaction of dihydroxy compounds in which only one atom separates A¹ and A². As used herein, the term “dihydroxy compound” includes, for example, bisphenol compounds having general formula (III) as follows: 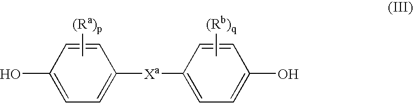
wherein R^{a} and R^{b} each independently represent hydrogen, a halogen atom, preferably bromine, or a monovalent hydrocarbon group; p and q are each independently integers from 0 to 4; and X^{a} represents one of the groups of formula (IV): 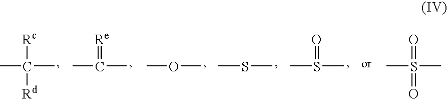
wherein R^{c} and R^{d} each independently represent a hydrogen atom or a monovalent linear or cyclic hydrocarbon group, and R^{e} is a divalent hydrocarbon group, oxygen, or sulfur.

Examples of the types of bisphenol compounds that may be represented by formula (III) include the bis(hydroxyaryl)alkane series such as, 1,1-bis(4-hydroxyphenyl)methane, 1,1-bis(4-hydroxyphenyl)ethane, 2,2-bis(4-hydroxyphenyl)propane (or bisphenol-A), 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, bis(4-hydroxyphenyl)phenylmethane, 2,2-bis(4-hydroxy-1-methylphenyl)propane, 1,1-bis(4-hydroxy-t-butylphenyl)propane, 2,2-bis(4-hydroxy-3-bromophenyl)propane, or the like; bis(hydroxyaryl)cycloalkane series such as, 1,1-bis(4-hydroxyphenyl)cyclopentane, 1,1-bis(4-hydroxyphenyl)cyclohexane, or the like, or combinations comprising at least one of the foregoing bisphenol compounds.

Other bisphenol compounds that may be represented by formula (III) include those where X is —O—, —S—, —SO— or —S(O)₂—. Some examples of such bisphenol compounds are bis(hydroxyaryl)ethers such as 4,4′-dihydroxy diphenylether, 4,4′-dihydroxy-3,3′-dimethylphenyl ether, or the like; bis(hydroxy diaryl)sulfides, such as 4,4′-dihydroxy diphenyl sulfide, 4,4′-dihydroxy-3,3′-dimethyl diphenyl sulfide, or the like; bis(hydroxy diaryl)sulfoxides, such as, 4,4′-dihydroxy diphenyl sulfoxides, 4,4′-dihydroxy-3,3′-dimethyl diphenyl sulfoxides, or the like; bis(hydroxy diaryl)sulfones, such as 4,4′-dihydroxy diphenyl sulfone, 4,4′-dihydroxy-3,3′-dimethyl diphenyl sulfone, or the like; or combinations comprising at least one of the foregoing bisphenol compounds.

Other bisphenol compounds that may be utilized in the polycondensation of polycarbonate are represented by the formula (V) 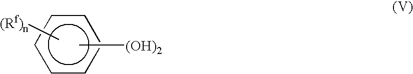
wherein, R^{f}, is a halogen atom of a hydrocarbon group having 1 to 10 carbon atoms or a halogen substituted hydrocarbon group; n is a value from 0 to 4. When n is at least 2, R^{f} may be the same or different. Examples of bisphenol compounds that may be represented by the formula (V), are resorcinol, substituted resorcinol compounds such as 5-methyl resorcin, 5-ethyl resorcin, 5-propyl resorcin, 5-butyl resorcin, 5-t-butyl resorcin, 5-phenyl resorcin, 5-cumyl resorcin, or the like; catechol, hydroquinone, substituted hydroquinones, such as 3-methyl hydroquinone, 3-ethyl hydroquinone, 3-propyl hydroquinone, 3-butyl hydroquinone, 3-t-butyl hydroquinone, 3-phenyl hydroquinone, 3-cumyl hydroquinone, or the like; or combinations comprising at least one of the foregoing bisphenol compounds.

Bisphenol compounds such as 2,2,2′,2′-tetrahydro-3,3,3′,3′-tetramethyl-1,1′-spirobi-[1H-indene]-6,6′-diol represented by the following formula (VI) may also be used.

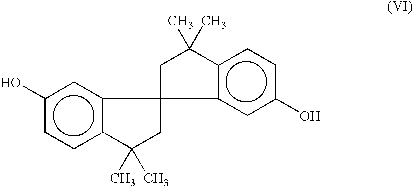

Suitable polycarbonates further include those derived from bisphenols containing alkyl cyclohexane units. Such polycarbonates have structural units corresponding to the formula (VII) 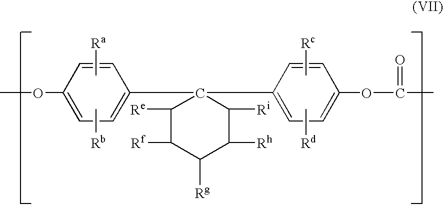
wherein R^{a}-R^{d} are each independently hydrogen, C₁-C₁₂ hydrocarbyl, or halogen; and R^{e}-Rⁱ are each independently hydrogen, C₁-C₁₂ hydrocarbyl. As used herein, “hydrocarbyl” refers to a residue that contains only carbon and hydrogen. The residue may be aliphatic or aromatic, straight-chain, cyclic, bicyclic, branched, saturated, or unsaturated. The hydrocarbyl residue may contain heteroatoms over and above the carbon and hydrogen members of the substituent residue. Thus, when specifically noted as containing such heteroatoms, the hydrocarbyl residue may also contain carbonyl groups, amino groups, hydroxyl groups, or the like, or it may contain heteroatoms within the backbone of the hydrocarbyl residue. Alkyl cyclohexane containing bisphenols, for example the reaction product of two moles of a phenol with one mole of a hydrogenated isophorone, are useful for making polycarbonate resins with high glass transition temperatures and high heat distortion temperatures. Such isophorone bisphenol-containing polycarbonates have structural units corresponding to the formula (VIII) 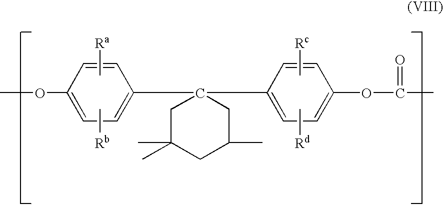
wherein R^{a}-R^{d} are as defined above. These isophorone bisphenol based resins, including polycarbonate copolymers made containing non-alkyl cyclohexane bisphenols and blends of alkyl cyclohexyl bisphenol containing polycarbonates with non-alkyl cyclohexyl bisphenol polycarbonates, are supplied by Bayer Co. under the APEC trade name. The preferred bisphenol compound is bisphenol A.

Typical carbonate precursors include the carbonyl halides, for example carbonyl chloride (phosgene), and carbonyl bromide; the bis-haloformates, for example the bis-haloformates of dihydric phenols such as bisphenol A, hydroquinone, or the like, and the bis-haloformates of glycols such as ethylene glycol and neopentyl glycol; and the diaryl carbonates, such as diphenyl carbonate, di(tolyl)carbonate, and di(naphthyl)carbonate. The preferred carbonate precursor for the interfacial reaction is carbonyl chloride.

It is also possible to employ polycarbonates resulting from the polymerization of two or more different dihydric phenols or a copolymer of a dihydric phenol with a glycol or with a hydroxy- or acid-terminated polyester or with a dibasic acid or with a hydroxy acid or with an aliphatic diacid in the event a carbonate copolymer rather than a homopolymer is desired for use. Generally, useful aliphatic diacids have about 2 to about 40 carbons. A preferred aliphatic diacid is dodecanedioic acid.

Branched polycarbonates, as well as blends of linear polycarbonate and a branched polycarbonate may also be used in the data storage device. The branched polycarbonates may be prepared by adding a branching agent during polymerization. These branching agents may comprise polyfunctional organic compounds containing at least three functional groups, which may be hydroxyl, carboxyl, carboxylic anhydride, haloformyl, and combinations comprising at least one of the foregoing branching agents. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl)α,α-dimethyl benzyl)phenol), 4-chloroformyl phthalic anhydride, trimesic acid, benzophenone tetracarboxylic acid, or the like, or combinations comprising at least one of the foregoing branching agents. The branching agents may be added at a level of about 0.05 to about 2.0 weight percent (wt %), based upon the total weight of the polycarbonate in a given layer.

In one embodiment, the polycarbonate may be produced by a melt polycondensation reaction between a dihydroxy compound and a carbonic acid diester. Examples of the carbonic acid diesters that may be utilized to produce the polycarbonates are diphenyl carbonate, bis(2,4-dichlorophenyl)carbonate, bis(2,4,6-trichlorophenyl)carbonate, bis(2-cyanophenyl)carbonate, bis(o-nitrophenyl)carbonate, ditolyl carbonate, m-cresyl carbonate, dinaphthyl carbonate, bis(diphenyl)carbonate, diethyl carbonate, dimethyl carbonate, dibutyl carbonate, dicyclohexyl carbonate, or the like, or combinations comprising at least one of the foregoing carbonic acid diesters. The preferred carbonic acid diester is diphenyl carbonate.

Preferably, the number average molecular weight of the polycarbonate is about 3,000 to about 1,000,000 grams/mole (g/mole). Within this range, it is desirable to have a number average molecular weight of greater than or equal to about 10,000, preferably greater than or equal to about 20,000 g/mole, and more preferably greater than or equal to about 25,000 g/mole. Also desirable is a number average molecular weight of less than or equal to about 100,000, preferably less than or equal to about 75,000, more preferably less than or equal to about 50,000 g/mole, and most preferably less than or equal to about 35,000 g/mole.

Suitable polyesters include those derived from an aliphatic, cycloaliphatic, or aromatic diol, or mixtures thereof, containing from 2 to about 10 carbon atoms and an aliphatic, cycloaliphatic, or aromatic dicarboxylic acid, and have repeating units of the following general formula (IX) 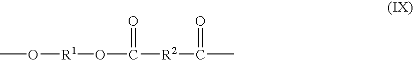
wherein R¹ and R² are each independently a divalent C₁-C₂₀ aliphatic radical, a C₂-C₁₂ cycloaliphatic alkyl radical, or a C₆-C₂₄ aromatic radical. Preferably, R¹ is a divalent aliphatic or aromatic radical and R² is a divalent aromatic radical.

The preferred diols are the aromatic diols such as the bisphenols listed above under formulas (III) and (V). However a proportion of aliphatic diols may also be used in conjunction with the aromatic diols in the preparation of polyesters. Suitable examples of such aliphatic diols include ethylene glycol, propylene glycols such as 1,2- and 1,3-propylene glycol; butane diols such as 1,3- and 1,4-butane diol; diethylene glycol, 2,2-dimethyl-1,3-propane diol, 2-ethyl, 2-methyl, 1,3-propane diol, 1,3- and 1,5-pentane diol, dipropylene glycol, 2-methyl-1,5-pentane diol, 1,6-hexane diol, 1,4-cyclohexane dimethanol and particularly its cis- and trans-isomers, triethylene glycol, 1,10-decane diol, and mixtures of any of the foregoing.

Examples of aromatic dicarboxylic acids represented by the decarboxylated residue R² are isophthalic or terephthalic acid, 1,2-di(p-carboxyphenyl)ethane, 4,4′-dicarboxydiphenyl ether, 4,4′ bisbenzoic acid, and mixtures thereof. All of these acids contain at least one aromatic nucleus. Acids containing fused rings can also be present, such as in 1,4-1,5- or 2,6-naphthalene dicarboxylic acids. The preferred dicarboxylic acids are terephthalic acid, isophthalic acid, naphthalene dicarboxylic acid, or the like, or a combination comprising at least one of the foregoing dicarboxylic acids.

Also contemplated herein are copolyesters comprising about 0.5 to about 30 percent by weight (wt %), of units derived from aliphatic acids and/or aliphatic polyols with the remainder of the polyester being a resorcinol aryl polyesters derived from aromatic diols and aromatic polyols.

Suitable organic polymers include “polyarylates”, which is the common term referring to polyesters of aromatic dicarboxylic acids and bisphenols. Polyarylate copolymers including carbonate linkages in addition to the aryl ester linkages, known as polyester-carbonates, are also suitable. These aryl esters may be used alone or in combination with each other or more preferably in combination with bisphenol polycarbonates. These organic polymers can be prepared in solution or by melt polymerization from aromatic dicarboxylic acids or their ester forming derivatives and bisphenols and their derivatives.

In general it is preferred for the organic polymers to comprise at least one diphenol residue in combination with at least one aromatic dicarboxylic acid residue. The preferred diphenol residue, illustrated in formula (X), is derived from a 1,3-dihydroxybenzene moiety, commonly referred to throughout this specification as resorcinol or resorcinol moiety. Resorcinol or resorcinol moieties include both unsubstituted 1,3-dihydroxybenzene and substituted 1,3-dihydroxybenzenes.

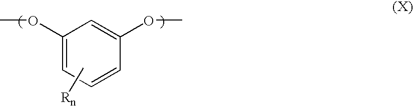

In formula (X), R is at least one of C₁₋₁₂ alkyl or halogen, and n is 0 to 3. Suitable dicarboxylic acid residues include aromatic dicarboxylic acid residues derived from monocyclic moieties, preferably isophthalic acid, terephthalic acid, or mixtures of isophthalic and terephthalic acids, or from polycyclic moieties such as diphenyl dicarboxylic acid, diphenylether dicarboxylic acid, and naphthalene-2,6-dicarboxylic acid, or the like, or combinations comprising at least one of the foregoing polycyclic moieties. The preferred polycyclic moiety is naphthalene-2,6-dicarboxylic acid.

Preferably, the aromatic dicarboxylic acid residues are derived from mixtures of isophthalic and/or terephthalic acids as typically illustrated in formula (XI).

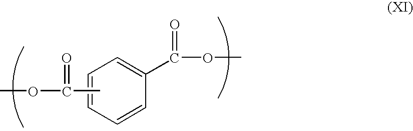

Therefore, in one embodiment the organic polymers comprise resorcinol arylate polyesters as illustrated in formula (XII) wherein R and n are previously defined for formula (X). 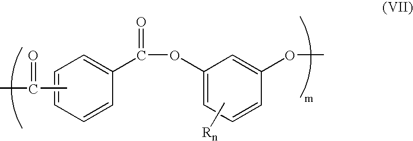
wherein R is at least one of C₁₋₁₂ alkyl or halogen, n is 0 to 3, and m is at least about 8. It is preferred for R to be hydrogen for the Fries molecular rearrangement to occur. Preferably, n is zero and m is about 10 and about 300. The molar ratio of isophthalate to terephthalate is about 0.25:1 to about 4.0:1.

In yet another embodiment, the organic polymer comprises thermally stable resorcinol arylate polyesters that have polycyclic aromatic radicals as shown in formula (XIII) 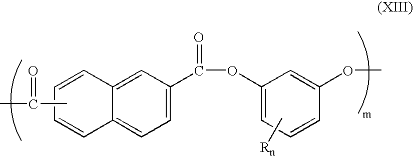
wherein R is at least one of C₁₋₁₂ alkyl or halogen, n is 0 to 3, and m is at least about 8.

In another embodiment, the organic polymers are block copolyestercarbonates, which comprise carbonate and arylate blocks. They include polymers comprising structural units of the formula (XIV) 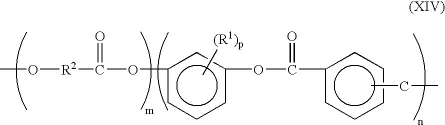
wherein each R¹ is independently halogen or C₁₋₁₂ alkyl, m is at least 1, p is about 0 to about 3, each R² is independently a divalent organic radical, and n is at least about 4. Preferably n is at least about 10, more preferably at least about 20 and most preferably about 30 to about 150. Preferably m is at least about 3, more preferably at least about 10 and most preferably about 20 to about 200. In an exemplary embodiment m is present in an amount of about 20 and 50.

Blends of organic polymers may also be used to form the data storage devices. Preferred organic polymer blends are polycarbonate (PC)-poly(1,4-cyclohexane-dimethanol-1,4-cyclohexanedicarboxylate) (PCCD), PC-poly(cyclohexanedimethanol-co-ethylene terephthalate) (PETG), PC-polyethylene terephthalate (PET), PC-polybutylene terephthalate (PBT), PC-polymethylmethacrylate (PMMA), PC-PCCD-PETG, resorcinol aryl polyester-PCCD, resorcinol aryl polyester-PETG, PC-resorcinol aryl polyester, resorcinol aryl polyester-polymethylmethacrylate (PMMA), resorcinol aryl polyester-PCCD-PETG and the like.

It is generally desirable to have the organic polymer in the form of a film having a thickness of about 1 to about 1,000 micrometers (μm). Within this range, a thickness of greater than or equal to about 2, preferably greater than or equal to about 5 and more preferably greater than or equal to about 7 μm. Also desirable within this range is a thickness of less than or equal to about 450, preferably less than or equal to about 400 and more preferably less than or equal to about 350 μm. An exemplary film thickness is about 10 μm. If it is desired to manufacture a pattern in the adjoining successive layers of a multilayered film, it is preferred to have each layer less than or equal to about 10 μm.

In the manufacture of the data storage media, UV light having a wavelength of about 290 to about 400 nanometers (nm) is used to irradiate the organic polymer to form the pattern. The UV light source generally delivers energy of about 1 to about 20 milliwatt/square centimeter (mW/cm²) to the organic polymer. Within this range, it is desirable to deliver greater than or equal to about out 2, preferably greater than or equal to about 3 mW/cm² to the organic polymer. Also desirable is an energy of less than or equal to about 17, preferably less than or equal to about 15, and more preferably less than or equal to about 10 mW/cm² to the organic film.

The organic polymer is irradiated for a time period of about 30 seconds to about 5 minutes. Within this range, it is desirable to irradiate the organic polymer for a time period of greater than or equal to about 45 seconds, preferably greater than or equal to about 60 seconds, and more preferably greater than or equal to about 75 seconds. Also desirable is a time period of less than or equal to about 4.5 minutes, preferably less than or equal to about 4 minutes and more preferably less than or equal to about 3 minutes. An exemplary time period for irradiating an exemplary film of about 10 μm thickness is about 2 minutes.

Upon irradiation, the refractive index of the organic polymer increases as a result of undergoing a Fries molecular rearrangement. The difference in refractive index between the irradiated region and those regions that are not irradiated are about 0.0001 to about 0.1. Within this range a difference of refractive index of greater than or equal to about 0.0002, preferably greater than or equal to about 0.0003, and more preferably greater than or equal to about 0.0005 is generally desired. Also desirable is a difference in refractive index of less than or equal to about 0.09, preferably less than or equal to about 0.08, and more preferably less than or equal to about 0.05 is desired.

In one method of manufacturing a pattern, a film of the organic polymer is first cast from a solvent onto a substrate. The solvent is then removed from the film following which the film on the substrate is subjected to irradiation to form the pattern. The pattern can be used as a data storage device if desired. This has not been reduced to practice.

In another method of manufacturing the pattern, a multilayered film is produced and then subjected to irradiation with UV light. It may be desirable to irradiate only a single layer of a multilayered film thereby creating a pattern in a single layer, or it may be desirable to simultaneously irradiate multiple layers, thereby creating a pattern in multiple layers. In one embodiment, during the irradiation, the organic polymer to be irradiated may be temporarily covered with a non-absorbing UV coating such as quartz, sapphire, or the like. In another embodiment, related to manufacturing the pattern, the organic polymer to be patterned may be disposed between a first and a second substrate, wherein the first and two substrates comprise a thermoplastic resin. The organic polymer may then be irradiated with UV light to form a pattern that is used as a data storage media. In yet another embodiment, the data is stored pagewise in a three dimensional array by laser writing.

In one embodiment, the creation of pattern can be used to produce holographic medium for a data storage media. In order to record a holographic pattern onto the organic polymer, a light source such as a laser light is split into two with a beam splitter. One beam of the split light is irradiated onto an object to be recorded, while the other beam is reflected with a reflector. A recording medium (e.g., the organic polymer) is arranged at a specified position. At the specified position, an interference fringe is formed with reference light reflected from the reflector and object light reflected from the object. When the object light and the reference light enter the organic polymer through the same face, a transmission type holographic pattern is formed. When the object light and the reference light enter from a front face and a rear face respectively, a reflection type holographic pattern is formed.

The organic polymers may be advantageously used to form data storage devices, photonic communication devices, or waveguide materials. The organic polymers having the pattern may be advantageously used in the exterior body panels of automobiles for decorative and advertising purposes. They may also be used in safety devices, identification systems such as identity cards, passports, and the like.

One of the advantages of using resorcinol aryl polyesters for producing the holographic patterns is the minimal shrinkage when compared with other polyesters such as hydroquinone polyesters, and the like. The resorcinol aryl polyester generally displays a shrinkage of less than or equal to about 5 volume percent (vol %), preferably less than or equal to about 3, and more preferably less than or equal to about 2 vol %, when compared with the original volume of the resorcinol aryl polyester that has been subjected to a Fries rearrangement. In one embodiment, the resorcinol aryl polyester generally displays a shrinkage of at least 10 vol %, preferably at least 12 vol %, and more preferably at least 15 vol % less, when compared the shrinkage of other polyesters such as hydroquinone polyesters when both have been subjected to the same amount of irradiation and when both have undergone the same change in refractive index.

In another embodiment, one of the advantages of the resorcinol polyesters is that they generally undergo less yellowing with aging as compared with other polyesters or polyarylates. The resorcinol aryl polyester generally undergoes at least 50% less yellowing, preferably at least 75% less yellowing and more preferably at least 90% less yellowing than other polyesters that have been subjected to the same amount of irradiation. In yet another embodiment, there is no change in the refractive index (after undergoing a photofries rearrangement) due to yellowing when exposed to visible light for a period of greater than or equal to about 3, preferably greater than or equal to about 4, and more preferably greater than or equal to about 6 months after the formation of the pattern.

The following examples, which are meant to be exemplary, not limiting, illustrate compositions and methods of manufacturing of some of the various embodiments of the organic polymers and the refractive index differences described herein.

### EXAMPLES

### Example 1

This example was undertaken to develop a pattern by irradiating a Sollx copolymer film manufactured by General Electric Corporation. The copolymer comprises 90 mole percent (mole %) of isophthalate terephthalate resorcinol and 10 mole % polycarbonate. The film was spin coated onto a glass substrate. The solvent used was chloroform. The polymer solution contained 80 to 96% solvent by weight. The solvent was removed under a vacuum and the film was covered under a quartz mask. The mask is patterned with a chrome pattern, which blocks light transmission in specific areas. The mask was patterned with chrome diffraction grating of 125 or 250 or 500 or 1000 line pairs per inch. After exposure of the film to broadband UV light having a wavelength of 200 to 500 nm for 3 minutes, the mask was removed. The light source was not monochromatic. It emitted light across the entire wavelength range. The resulting film was photo-patterned with the diffraction grating and diffracted red laser light at 632 nm. By patterning the thin film with the diffraction grating, it has been demonstrated that these polymers can be photo-patterned using a UV light source. Further applications of this example could include photopatternable wave guides, optical backplanes, optical circuit boards, and other photonic devices.

### Example 2

A 15 mil (approximately 300 micrometers) film of a polyestercarbonate containing a 90 mole % of ester and 10 mole % of carbonate in which the diacid component of the ester was derived from a 1:1 mole ratio of terephthalate to isophthalate, the diol component of the ester derived from resorcinol, and the carbonate component derived from bisphenol A and phosgene was passed 5 times under two UV lamps using lamp to film distance of 2.1 inches and a belt speed of 10 feet per minute. One UV lamp contained a 600 Watt H bulb while the other contained a 600 Watt V bulb. Both lamps were on high power. The UV processor used was a Fusion EPIC 6000UV curing system. The refractive index of both the exposed an unexposed film was determined using a spectroscopic ellipsometer model WVASE32 from J. A. Woollam Co., Inc. The refractive index of the film before exposure to the UV light and after exposure is shown in FIG. 2.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for manufacturing data storage media comprising:
irradiating at least a portion of an organic polymer comprising a resorcinol arylate polyester with a UV beam having a wavelength of about 290 to about 400 nanometers so as to impart an energy of about 1 to about 20 milliwatt/square centimeter to the irradiated portion of the organic polymer.

2. The method of claim 1, wherein the resorcinol arylate polyester has the structure of formula (XII) 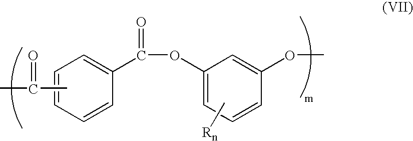
wherein R is at least one of C₁₋₁₂ alkyl or halogen, n is 0 to 3, and m is at least about 8.

3. The method of claim 2, wherein m is about 10 and about 300.

4. The method of claim 1, wherein the resorcinol arylate polyester has the structure of formula (XIII) 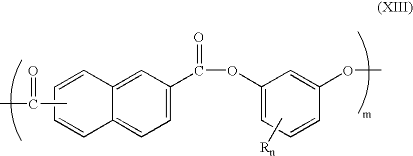
wherein R is at least one of C₁₋₁₂ alkyl or halogen, n is 0 to 3, and m is at least about 8.

5. The method of claim 4, wherein m is about 10 and about 300.

6. The method of claim 1, wherein the organic polymer has the structure of formula (XIV) 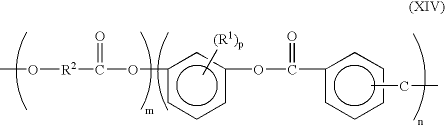
wherein each R¹ is independently halogen or C₁₋₁₂ alkyl, m is at least 1, p is about 0 to about 3, each R² is independently a divalent organic radical, and n is at least about 4.

7. The method of claim 6, wherein m is about 2 to about 200 and n is about 30 to about 150.

8. The method of claim 1, wherein the organic polymer is further blended with a polycarbonate.

9. The method of claim 1, wherein the organic polymer is irradiated for a time period of about 30 seconds to about 5 minutes.

10. The method of claim 1, wherein the organic polymer is in the form of a film having a thickness of about 1 to about 1,000 micrometers.

11. The method of claim 10, wherein the film comprises a single layer.

12. The method of claim 10, wherein the film is multilayered.

13. The method of claim 1, wherein the irradiation promotes a Fries molecular rearrangement in the organic polymer.

14. The method of claim 1, wherein the irradiation produces a difference in refractive index of about 0.0001 to about 0.1 between an irradiated portion and an unirradiated portion of the organic polymer.

15. The method of claim 1, wherein the irradiating produces a pattern in the organic polymer.

16. The method of claim 1, wherein the organic polymer has a shrinkage of less than or equal to about 5 volume percent when compared with the volume of the organic polymer prior to the irradiation.

17. The method of claim 1, wherein the organic polymer undergoes a shrinkage of at least 10 volume percent less than the shrinkage of a hydroquinone polyester when both are subjected to the same amount of irradiation per unit volume.

18. The method of claim 1, wherein the organic polymer undergoes a yellowing of at least 50 percent less than the yellowing of a hydroquinone polyester when both are subjected to the same amount of irradiation per unit volume.

19. A holographic pattern manufactured by the method of claim 1.

20. An article manufactured by the method of claim 1.

21. A data storage device manufactured by the method of claim 1.

22. A photonic communication device manufactured by the method of claim 1.

23. A waveguide manufactured by the method of claim 1.
